(19) United States
(12) Patent Application Publication
(10) Pub. No.: US 2025/0371597 A1
(43) Pub. Date: Dec. 4, 2025

(54) SEASONALITY PREDICTION USING LARGE LANGUAGE MACHINE-LEARNED MODEL

(71) Applicant: Maplebear Inc., San Francisco, CA (US)

(72) Inventors: Shih-Ting Lin, Santa Clara, CA (US); Shishir Kumar Prasad, Fremont, CA (US); Danna Weintraub, New York, NY (US); Rohan Salantry, Walnut Creek, CA (US); Satish Boggarapu, Media, PA (US)

(21) Appl. No.: 18/676,332

(22) Filed: May 28, 2024

(51) Int. Cl. G06Q 30/0601; G06Q 30/0201

(52) U.S. Cl. CPC G06Q 30/0627; G06Q 30/0201; G06Q 30/0603; G06Q 30/0643

(57) ABSTRACT

An online system performs an inference task in conjunction with the model serving system infer seasonality of items in an item catalog hosted by the online system. The online system generates and provides a prompt to a machine-learned language model to output a list of item categories predicted to be in season for a particular time period and a particular geographical location, e.g., associated with a requesting user. The language model outputs the list of item categories predicted to be in season. The online system validates the list by leveraging the language model and/or historical user engagement data. The online system maps items in the item catalog to the seasonal item categories and tags the mapped items with an in-season badge for display with the item in an ordering interface to the requesting user.

### BACKGROUND

Online systems provide platforms for connecting requesting users and fulfillment locations. The requesting users provide orders to the online system to be fulfilled by fulfillment users at the fulfillment locations. Being remote from the fulfillment locations, however, the requesting users lack insight into seasonality information of the items.

### SUMMARY

In accordance with one or more aspects of the disclosure, an online system performs an inference of seasonal item categories for tagging items with in-season badges. The online system crafts a prompt for execution by a language model. The prompt may include the geographical location (e.g., of the requesting user) and a current time period. The online system provides the prompt to the language model for execution. Upon execution by the language model, the online system receives a response indicating a list of seasonal item categories, e.g., berries, citruses, stone fruits, tomatoes, pineapples, etc. The online system may further validate the seasonality inference from the model by generating a confidence score using a further prompt to the language model and/or historical user engagement. If the confidence score is above a threshold, the online system may validate the item category as being in-season. Such a validation process helps to protect against hallucinations by the language model, thereby solving a technical problem in the use of language models. The online system maps items in the catalog to the seasonal item categories. The online system may tag the mapped items with in-season badges to be displayed in the ordering interface of the requesting user client device.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart illustrating seasonality prediction and validation, in accordance with one or more embodiments.

FIG. 4A is a method flowchart for the method of inferring seasonality of items in a catalog hosted by an online system, in accordance with one or more embodiments.

FIG. 4B is a method flowchart for the method of validating seasonality of item categories, in accordance with one or more embodiments.

FIG. 5 is an example ordering interface with in-season badge tagged onto an item, in accordance with one or more embodiments.

### DETAILED DESCRIPTION

### Online System Environment

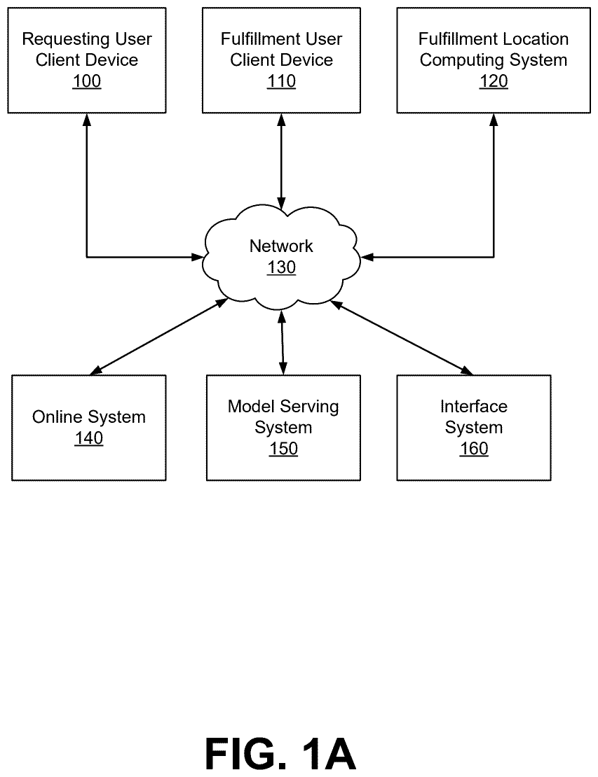

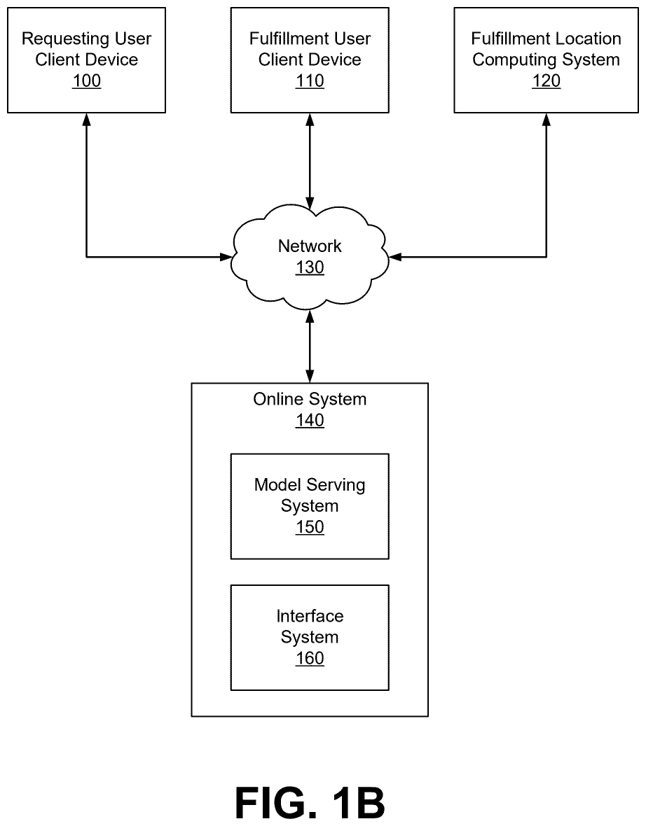

FIG. 1A illustrates an example system environment for an online system 140, in accordance with one or more embodiments. The system environment illustrated in FIG. 1A includes a requesting user client device 100, a fulfillment user client device 110, a fulfillment location computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and fulfillment locations may be generically referred to as “requesting users” of the online system 140. Additionally, while one requesting user client device 100, fulfillment user client device 110, and fulfillment location computing system 120 are illustrated in FIG. 1, any number of requesting users, fulfillment users, and fulfillment locations may interact with the online system 140. As such, there may be more than one requesting user client device 100, fulfillment user client device 110, or fulfillment location computing system 120.

The requesting user client device 100 is a client device through which a requesting user may interact with the fulfillment user client device 110, the fulfillment location computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. An order specifies a set of items to be delivered to the requesting user. An “item”, as used herein, means a good or product that can be provided to the requesting user through the online system 140. The order may include item identifiers (e.g., a stock keeping unit or a price look-up code) for items to be delivered to the requesting user and may include quantities of the items to be delivered. Additionally, an order may further include a delivery location to which the ordered items are to be delivered and a timeframe during which the items should be delivered. In some embodiments, the order also specifies one or more fulfillment locations from which the ordered items should be collected.

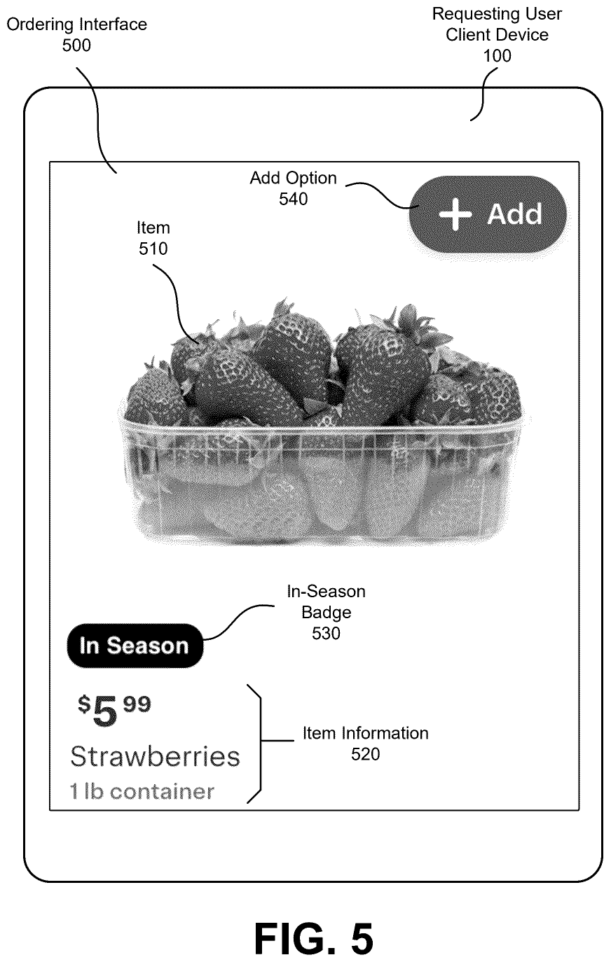

The requesting user client device 100 presents an ordering interface to the requesting user. The ordering interface is a requesting user interface that the requesting user can use to place an order with the online system 140. The ordering interface may be part of a client application operating on the requesting user client device 100. The ordering interface allows the requesting user to search for items that are available through the online system 140 and the requesting user can select which items to add to a “shopping list.” The ordering interface may further tag items with in-season badges to denote items that are currently in-season around a requesting user's geographical location. An example ordering interface is described in FIG. 5. A “shopping list,” as used herein, is a tentative set of items that the requesting user has selected for an order but that has not yet been finalized for an order. The ordering interface allows a requesting user to update the shopping list, e.g., by changing the quantity of items, adding or removing items, or adding instructions for items that specify how the item should be collected.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the requesting user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the fulfillment location computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user services an order by collecting the items listed in the order from a fulfillment location. The fulfillment user client device 110 presents the items that are included in the requesting user's order to the fulfillment user in a collection interface. The collection interface is a requesting user interface that provides information to the fulfillment user on which items to collect for a requesting user's order and the quantities of the items. In some embodiments, the collection interface provides multiple orders from multiple requesting users for the fulfillment user to service at the same time from the same fulfillment location. The collection interface further presents instructions that the requesting user may have included related to the collection of items in the order. Additionally, the collection interface may present a location of each item in the fulfillment location, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the fulfillment location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the fulfillment location to the delivery location. Where a fulfillment user is servicing more than one order, the fulfillment user client device 110 identifies which items should be delivered to which delivery location. The fulfillment user client device 110 may provide navigation instructions from the fulfillment location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the fulfillment location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user such that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

In one or more embodiments, the fulfillment user is a single person who collects items for an order from a fulfillment location and delivers the order to the delivery location for the order. Alternatively, more than one person may serve the role as a fulfillment user for an order. For example, multiple people may collect the items at the fulfillment location for a single order. Similarly, the person who delivers an order to its delivery location may be different from the person or people who collected the items from the fulfillment location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi- or fully-autonomous robot may collect items in a fulfillment location for an order and an autonomous vehicle may deliver an order to a requesting user from a fulfillment location.

The fulfillment location computing system 120 is a computing system operated by a fulfillment location that interacts with the online system 140. As used herein, a “fulfillment location” is an entity that operates a location storing items, e.g., a store, warehouse, or other building from which a fulfillment user can collect items. The fulfillment location computing system 120 stores and provides item data to the online system 140 and may regularly update the online system 140 with updated item data. For example, the fulfillment location computing system 120 provides item data indicating which items are available at a fulfillment location and the quantities of those items. Additionally, the fulfillment location computing system 120 may transmit updated item data to the online system 140 when an item is no longer available at the fulfillment location. Additionally, the fulfillment location computing system 120 may provide the online system 140 with updated item prices, sales, or availabilities. Additionally, the fulfillment location computing system 120 may receive payment information from the online system 140 for orders serviced by the online system 140.

The requesting user client device 100, the fulfillment user client device 110, the fulfillment location computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a fulfillment location. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a fulfillment location and delivers the ordered items to the requesting user. The online system 140 may charge a requesting user for the order and may forward a portion to the fulfillment user and the fulfillment location.

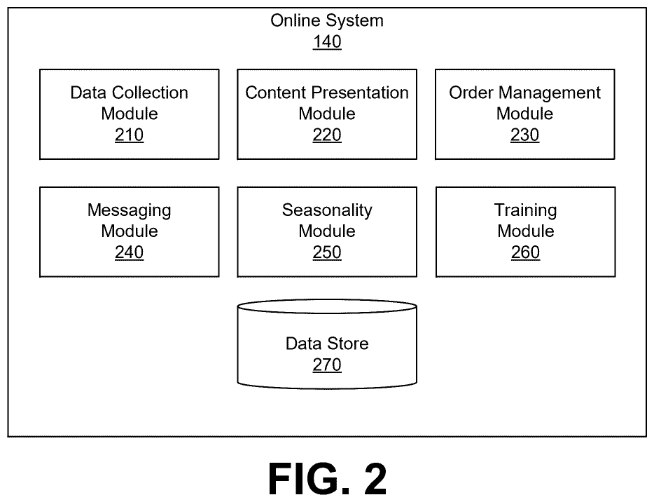

As an example, the online system 140 may allow a requesting user to order groceries from a grocery store fulfillment location. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery store fulfillment location to collect the groceries ordered by the requesting user. Once the fulfillment user has collected the groceries ordered by the requesting user, the fulfillment user delivers the groceries to a location transmitted to the fulfillment user client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the requesting user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 performs an inference of seasonal item categories for a particular geographical location and time period, in conjunction with the model serving system 150. The online system 140 crafts a prompt, which the model serving system 150 serves to the language model for execution. The prompt may include the geographical location (e.g., of the requesting user) and a current time period. The geographical locations may be geographical regions, e.g., the Northeast, the Midwest, the South, or the West. The geographical location may include multiple levels of granularity, e.g., the Pacific Northwest division of the West region. The time periods may be discretized portions of the year, e.g., weeks, months, seasons, etc. The model serving system 150 provides the prompt to the language model for execution. Upon execution by the language model, the model serving system 150 receives a response indicating a list of seasonal item categories, e.g., berries, citruses, stone fruits, tomatoes, pineapples, etc.

The online system 140 may further validate the seasonality inference using a language model and/or historical user engagement. To validate using the language model, the online system 140 may craft a subsequent prompt for an item category predicted to be in season. The subsequent prompt may include a prompt to return confidence scores relating to seasonality of the item category for the time periods, further given the geographical location. The model serving system 150 receives the confidence score for each time period. To validate using historical user engagement, the online system may retrieve historical user engagement for items mapped to the item category over the plurality of time periods, which may be further limited to geographical location. The online system 140 may generate a confidence score for each time period based on the user engagement. Within user engagement, different types of engagement may differentially affect the score. For example, searching for one or more item(s) mapped to the item category may positively affect the score. In a further example, adding the one or more item(s) mapped to the item category into an order by a requesting user may also positively affect the score, even more so than simply searching. The online system 140 may further aggregate the confidence score output by the language model and the confidence score determined based on historical user engagement, e.g., an average, or weighted average. If the confidence score is above a threshold, the online system 140 may validate the item category as being in-season. Conversely, if the confidence score does not surpass the threshold, the online system 140 may invalidate the item category. Such validation process aims to protect against hallucinations by the language model.

The online system 140 tags items in the catalog as in-season with the resulting seasonality inferences. For example, the online system 140 may recurrently perform seasonality prediction with the language model (e.g., every subsequent time period). The online system 140 maps items in the catalog to the seasonal item categories (e.g., that may be validated). The online system 140 may tag the mapped items with in-season badges to be displayed in the ordering interface of the requesting user client device 100. The mappings may also be stored by the online system 140.

FIG. 1B illustrates an example system environment for an online system 140, in accordance with one or more embodiments. The system environment illustrated in FIG. 1B includes a requesting user client device 100, a fulfillment user client device 110, a fulfillment location computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 210, a content presentation module 220, an order management module 230, a messaging module 240, a seasonality module 250, a training module 260, and a data store 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 270. The data collection module 210 may only collect data describing a requesting user if the requesting user has previously explicitly consented to the online system 140 collecting data describing the requesting user. Additionally, the data collection module 210 may encrypt all data, including sensitive or personal data, describing requesting users.

For example, the data collection module 210 collects requesting user data, which is information or data that describe characteristics of a requesting user. Requesting user data may include a requesting user's name, address, shopping preferences, favorite items, or stored payment instruments. The requesting user data also may include default settings established by the requesting user, such as a default fulfillment location, payment instrument, delivery location, or delivery timeframe. The data collection module 210 may collect the requesting user data from sensors on the requesting user client device 100 or based on the requesting user's interactions with the online system 140.

The data collection module 210 also collects item data, which is information or data that identifies and describes items that are available at a fulfillment location. The item data may include item identifiers for items that are available and may include quantities of items associated with each item identifier. Additionally, item data may also include attributes of items such as the size, color, weight, stock keeping unit (SKU), or serial number for the item. The item data may further include ordering rules associated with each item, e.g., if they exist. For example, age-restricted items such as alcohol and tobacco are flagged accordingly in the item data. Item data may also include information that is useful for predicting the availability of items in fulfillment locations. For example, for each item-fulfillment location combination (a particular item at a particular warehouse), the item data may include a time that the item was last found, a time that the item was last not found (a fulfillment user looked for the item but could not find it), the rate at which the item is found, or the popularity of the item. The data collection module 210 may collect item data from a fulfillment location computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects fulfillment user data, which is information or data that describes characteristics of fulfillment users. For example, the fulfillment user data for a fulfillment user may include the fulfillment user's name, the fulfillment user's location, how often the fulfillment user has services orders for the online system 140, a requesting user rating for the fulfillment user, which fulfillment locations the fulfillment user has collected items at, or the fulfillment user's previous shopping history. Additionally, the fulfillment user data may include preferences expressed by the fulfillment user, such as their preferred fulfillment locations to collect items at, how far they are willing to travel to deliver items to a requesting user, how many items they are willing to collect at a time, timeframes within which the fulfillment user is willing to service orders, or payment information by which the fulfillment user is to be paid for servicing orders (e.g., a bank account). The data collection module 210 collects fulfillment user data from sensors of the fulfillment user client device 110 or from the fulfillment user's interactions with the online system 140.

Additionally, the data collection module 210 collects order data, which is information or data that describes characteristics of an order. For example, order data may include item data for items that are included in the order, a delivery location for the order, a requesting user associated with the order, a fulfillment location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes requesting user data for requesting users associated with the order, such as requesting user data for a requesting user who placed the order or fulfillment user data for a fulfillment user who serviced the order.

In one or more embodiments, the data collection module 210 also collects communication data, which is different types of communication between fulfillment users and requesting users of the online system 140. For example, the data collection module 210 may obtain text-based, audio-call, video-call based communications between different fulfillment users and requesting users of the online system 140 as orders are submitted and fulfilled. The data collection module 210 may store the communication information by individual requesting user, individual fulfillment user, per geographical region, per subset of requesting users having similar attributes, and the like.

The content presentation module 220 selects content for presentation to a requesting user. For example, the content presentation module 220 selects which items to present to a requesting user while the requesting user is placing an order. The content presentation module 220 generates and transmits the ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items). The content presentation module 220 may further display in-season badges for items mapped to item categories predicted to be in season (an example of which is illustrated in FIG. 5).

The content presentation module 220 may use an item selection model to score items for presentation to a requesting user. An item selection model is a machine learning model that is trained to score items for a requesting user based on item data for the items and requesting user data for the requesting user. For example, the item selection model may be trained to determine a likelihood that the requesting user will order the item. In some embodiments, the item selection model uses item embeddings describing items and requesting user embeddings describing requesting users to score items. These item embeddings and requesting user embeddings may be generated by separate machine learning models and may be stored in the data store 270.

In some embodiments, the content presentation module 220 scores items based on a search query received from the requesting user client device 100. A search query is free text for a word or set of words that indicate items of interest to the requesting user. The content presentation module 220 scores items based on a relatedness of the items to the search query. For example, the content presentation module 220 may apply natural language processing (NLP) techniques to the text in the search query to generate a search query representation (e.g., an embedding) that represents characteristics of the search query. The content presentation module 220 may use the search query representation to score candidate items for presentation to a requesting user (e.g., by comparing a search query embedding to an item embedding).

In some embodiments, the content presentation module 220 scores items based on a predicted availability of an item. The content presentation module 220 may use an availability model to predict the availability of an item. An availability model is a machine learning model that is trained to predict the availability of an item at a fulfillment location. For example, the availability model may be trained to predict a likelihood that an item is available at a fulfillment location or may predict an estimated number of items that are available at a fulfillment location. The content presentation module 220 may weight the score for an item based on the predicted availability of the item. Alternatively, the content presentation module 220 may filter out items from presentation to a requesting user based on whether the predicted availability of the item exceeds a threshold.

In one or more embodiments, the content presentation module 220 receives one or more recommendations for presentation to the requesting user while the requesting user is engaged with the ordering interface. The list of ordered items of a requesting user may be referred to as a basket. As described in conjunction with FIGS. 1A and 1B, the recommendations are generated based on the inferred purpose of the basket of the requesting user and include one or more suggestions to the requesting user to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 220 may present the equivalent basket to the requesting user via the ordering interface with an indicator that states how an equivalent basket improves or is different from the existing basket (e.g., more cost-effective, healthier, sponsored by a certain organization). The content presentation module 220 may allow the requesting user to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 220 may present each suggested recipe and the list of additional ingredients for fulfilling the recipe to the requesting user. The content presentation module 220 may allow the requesting user to automatically place one or more additional ingredients in the basket of the requesting user.

The order management module 230 that manages orders for items from requesting users. The order management module 230 receives orders from a requesting user client device 100 and assigns the orders to fulfillment users for service based on fulfillment user data. For example, the order management module 230 assigns an order to a fulfillment user based on the fulfillment user's location and the location of the fulfillment location from which the ordered items are to be collected. The order management module 230 may also assign an order to a fulfillment user based on how many items are in the order, a vehicle operated by the fulfillment user, the delivery location, the fulfillment user's preferences on how far to travel to deliver an order, the fulfillment user's ratings by requesting users, or how often a fulfillment user agrees to service an order.

In some embodiments, the order management module 230 determines when to assign an order to a fulfillment user based on a delivery timeframe requested by the requesting user with the order. The order management module 230 computes an estimated amount of time that it would take for a fulfillment user to collect the items for an order and deliver the ordered item to the delivery location for the order. The order management module 230 assigns the order to a fulfillment user at a time such that, if the fulfillment user immediately services the order, the fulfillment user is likely to deliver the order at a time within the timeframe. Thus, when the order management module 230 receives an order, the order management module 230 may delay in assigning the order to a fulfillment user if the timeframe is far enough in the future.

When the order management module 230 assigns an order to a fulfillment user, the order management module 230 transmits the order to the fulfillment user client device 110 associated with the fulfillment user. The order management module 230 may also transmit navigation instructions from the fulfillment user's current location to the fulfillment location associated with the order. If the order includes items to collect from multiple fulfillment locations, the order management module 230 identifies the fulfillment locations to the fulfillment user and may also specify a sequence in which the fulfillment user should visit the fulfillment locations.

The order management module 230 may track the location of the fulfillment user through the fulfillment user client device 110 to determine when the fulfillment user arrives at the fulfillment location. When the fulfillment user arrives at the fulfillment location, the order management module 230 transmits the order to the fulfillment user client device 110 for display to the fulfillment user. As the fulfillment user uses the fulfillment user client device 110 to collect items at the fulfillment location, the order management module 230 receives item identifiers for items that the fulfillment user has collected for the order. In some embodiments, the order management module 230 receives images of items from the fulfillment user client device 110 and applies computer-vision techniques to the images to identify the items depicted by the images. The order management module 230 may track the progress of the fulfillment user as the fulfillment user collects items for an order and may transmit progress updates to the requesting user client device 100 that describe which items have been collected for the requesting user's order.

In some embodiments, the order management module 230 tracks the location of the fulfillment user within the fulfillment location. The order management module 230 uses sensor data from the fulfillment user client device 110 or from sensors in the fulfillment location to determine the location of the fulfillment user in the fulfillment location. The order management module 230 may transmit to the fulfillment user client device 110 instructions to display a map of the fulfillment location indicating where in the fulfillment location the fulfillment user is located. Additionally, the order management module 230 may instruct the fulfillment user client device 110 to display the locations of items for the fulfillment user to collect, and may further display navigation instructions for how the fulfillment user can travel from their current location to the location of a next item to collect for an order.

The order management module 230 determines when the fulfillment user has collected all of the items for an order. For example, the order management module 230 may receive a message from the fulfillment user client device 110 indicating that all of the items for an order have been collected. Alternatively, the order management module 230 may receive item identifiers for items collected by the fulfillment user and determine when all of the items in an order have been collected. When the order management module 230 determines that the fulfillment user has completed an order, the order management module 230 transmits the delivery location for the order to the fulfillment user client device 110. The order management module 230 may also transmit navigation instructions to the fulfillment user client device 110 that specify how to travel from the fulfillment location to the delivery location, or to a subsequent fulfillment location for further item collection. The order management module 230 tracks the location of the fulfillment user as the fulfillment user travels to the delivery location for an order, and updates the requesting user with the location of the fulfillment user so that the requesting user can track the progress of their order. In some embodiments, the order management module 230 computes an estimated time of arrival for the fulfillment user at the delivery location and provides the estimated time of arrival to the requesting user.

In some embodiments, the order management module 230 facilitates communication between the requesting user client device 100 and the fulfillment user client device 110. As noted above, a requesting user may use a requesting user client device 100 to send a message to the fulfillment user client device 110. The order management module 230 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the fulfillment user for servicing the order, and another portion of the total cost to the fulfillment location.

The messaging module 240 facilitates communication between the requesting user client device 100 and the fulfillment user client device 110. As noted above, a requesting user may use a requesting user client device 100 to communicate with a fulfillment user via the fulfillment user client device 110. The messaging module 240 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner. In one or more embodiments, the messaging module 240 may generate a messaging user interface for each client device that includes messages passed between two or more devices.

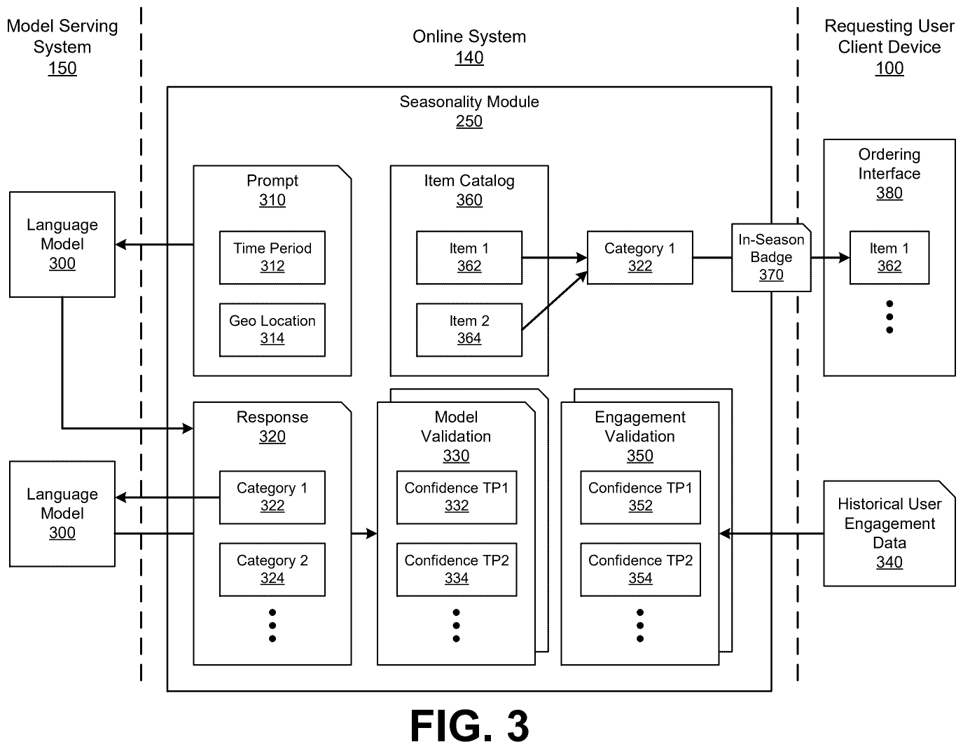

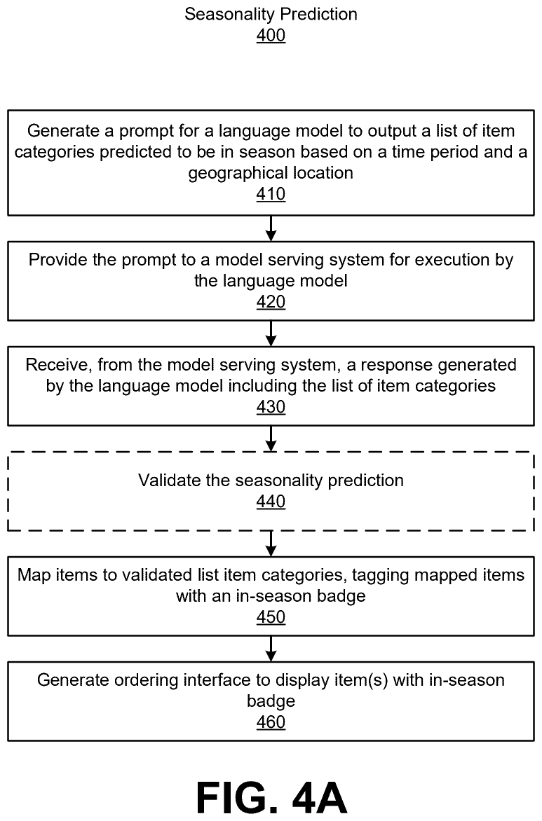

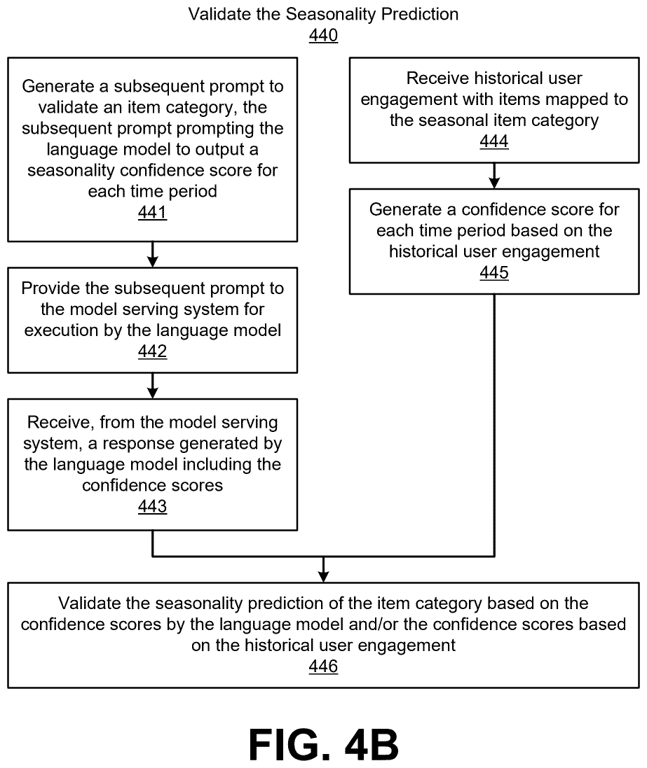

The seasonality module 250 infers seasonality of items in the catalog. The seasonality module 250 may craft prompts for execution by a language model to infer seasonality of items in a geographical location for a particular time period. For a prompt, the seasonality module 250 receives a response from the language model indicating a list of item categories inferred to be in-season. The seasonality module 250 may further validate the seasonality of the item categories using confidence scores generated by a language model and/or confidence scores determined based on historical user engagement. The seasonality module 250 maps items in the catalog to the seasonal item categories. Mapped items are tagged with an in-season badge to be displayed in an ordering interface presented to the requesting user client device 100. Details relating to the seasonality module 250 are described below in conjunction with FIGS. 3, 4A, and 4B.

The training module 260 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The training module 260 generates the set of parameters for a machine learning model by “training” the machine learning model. Once trained, the machine learning model uses the set of parameters to transform inputs into outputs.

The training module 260 trains a machine learning model based on a set of training examples. Each training example includes input data to which the machine learning model is applied to generate an output. For example, each training example may include requesting user data, fulfillment user data, item data, or order data. In some cases, the training examples also include a label which represents an expected output of the machine learning model. In these cases, the machine learning model is trained by comparing its output from input data of a training example to the label for the training example.

The training module 260 may apply an iterative process to train a machine learning model whereby the training module 260 trains the machine learning model on each of the set of training examples. To train a machine learning model based on a training example, the training module 260 applies the machine learning model to the input data in the training example to generate an output. The training module 260 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The training module 260 updates the set of parameters for the machine learning model based on the score generated by the loss function. For example, the training module 260 may apply gradient descent to update the set of parameters.

The training module 260 may perform fine-tuning of the one or more machine learning models. To perform fine-tuning, the training module 260 obtains training data derived from feedback data. Feedback data may be received from requesting users, fulfillment users, or fulfillment locations. For example, the fulfillment location may provide feedback agreeing or disagreeing with the seasonality prediction. In one or more embodiments, the training module 260 identifies positive instances of feedback where users provided positive feedback on the in-season badges. In another embodiment, the online system 140 identifies the positive instances in which the user did not provide negative feedback. In other embodiments, the training module 260 may identify negative instances of feedback where users provided negative feedback on the in-season badges.

The training module 260 may further tune crafting of prompts for execution by a language model. The training module 260 may receive season labels for items (e.g., by human curation, by trending scores from human engagement, etc.). The training module 260 may leverage these positive examples to refine the prompts to the language models. For example, the prompt may include the positive examples.

The data store 270 stores data used by the online system 140. For example, the data store 270 stores requesting user data, item data, order data, and fulfillment user data for use by the online system 140. User data may be stored in profiles, wherein the user data may have varying levels of accessibility by other users. For example, a requesting user's delivery address is not generally accessible, and would only be provided to a fulfillment user in the course of fulfilling an order on behalf of the requesting user. The data store 270 also stores trained machine learning models trained by the training module 260. For example, the data store 270 may store the set of parameters for a trained machine learning model on one or more non-transitory, computer-readable media. The data store 270 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 260 may further train parameters of the machine-learned model based on data specific to the online system 140 stored in the data store 270. As an example, the machine-learning training module 260 may obtain a pre-trained transformer language model and further fine tune the parameters of the transformer model using training data stored in the data store 270. The machine-learning training module 260 may provide the model to the model serving system 150 for deployment.

### Item Seasonality Prediction and Validation

FIG. 3 is a flowchart illustrating seasonality prediction and validation by the seasonality module 250, in accordance with one or more embodiments. The seasonality module 250 is a component of the online system 140. The workflow may include three stages. In a first stage, the seasonality module 250 infers seasonality of item categories using a language model. In a second optional stage, the seasonality module 250 validates the inferred seasonality of item categories. In a third stage, the seasonality module 250 maps items in the catalog to the inferred seasonal item categories for appending in-season badges to the mapped items for presentation in the ordering interface. The seasonality module 250 may perform some or all of the workflow on a recurrent basis to provide up-to-date seasonality insight to requesting users.

The seasonality module 250 infers seasonality of item categories by providing a prompt 310 to the language model 300. In one or more embodiments, the seasonality module 250 provides the prompt 310 to the model serving system 150 for execution by the language model 300. The prompt 310 may include a request to provide a list of seasonal item categories for a particular time period 312 and a particular geographical location 314. As noted above, the time periods may discretize the year, and the geographical locations may be subdivided geographical regions.

An example prompt to the LLM of the model serving system 150 may be:
“Provide a list of 20 seasonal produce items (fruits & vegetables) that are unique to the month of {insert month} or the season around month of {insert month} and can be found in typical stores in the state/province of {insert state/province}, {insert country}.”
   The example prompt above denotes the request for seasonal item categories for a particular time period and for a particular geographical location.

In some embodiments the example prompt may include additional instructions, e.g., list the seasonal item categories in descending confidence, request to use generic keywords and avoiding specific qualifiers, an example list of one or more seasonal item categories, instructions on formatting of the response, etc. For example, the prompt may specify one or more of the following:
“The recommendations should be sorted by confidence score descending, with the most confident recommendation at the top of the list. Only return recommendations if the confidence score is high.”
“The recommended products should use generic keywords that customers frequently use to search online for e-commerce sites, avoiding specific state or seasonal names. For example, instead of ‘Idaho potatoes,’ recommend ‘potatoes.’”
“Multiple-word recommendations should be separated by spaces, and special characters such as hyphens or quotes should be avoided. For instance, recommend ‘poboys’ rather than ‘po' boys.’”
“An example in-season produce item for the month of May is ‘berries.’”

The language model 300 may return a response 320 to the prompt. The response 320 includes a list of inferred seasonal item categories, e.g., category 1 322, category 2 324, etc. The response 320 may be formatted according to instructions included in the prompt 310. For example, category 1 322 may be of higher confidence than category 2 324.

The seasonality module 250 may further validate the seasonality predictions. To validate the seasonality predictions, the seasonality module 250 may further leverage a language model, e.g., the language model 300, and/or historical user engagement data 340. The seasonality module 250 may use either validation approach, or may leverage a combinative metric from the two approaches.

To validate with the language model 300, the seasonality module 250 may generate a subsequent prompt for execution by the language model 300. The language model used in the inference stage versus the language model used in the validation stage may be the same or different. The subsequent prompt validates the seasonality of an item category (e.g., category 1 322). The subsequent prompt may request the language model to provide a confidence score for seasonality of the time period (and may be further limited by the geographical location). The language model 300 returns model validation 330 including the confidence score per time period, e.g., confidence for time period (TP) 1 332, confidence for TP 2 324, etc.

An example subsequent prompt for the validation via the language model 300 may be:
“Provide the months when the given fresh produce (fruits or vegetables) is in season in {insert state}, {insert country}. If there is no month that the given fresh produce is in season, output an empty list. For each in-season month, also output a score from 0.00˜1.00 indicating if it's a peak season for the given fresh produce.
Think step-by-step.
Below is an input/output example:
==Example start==
Fresh Produce: XXX
Months:
AAA, 0.4
BBB, 0.74
CCC, 0.93
DDD, 0.97
EEE, 0.98
FFF, 0.85
GGG, 0.31
==End of the example==
Here is the fresh Produce you need to provide the in-season months and scores.
---------
Fresh Produce: {insert ITEM CATEGORY}
   This validation prompt includes a request to provide a confidence score (e.g., “output a score from 0.00˜1.00”) associated with seasonality for each of a plurality of time periods (e.g., “Provide the months when the given fresh produce (fruits or vegetables) is in season”) for an item category (e.g., “Here is the fresh Produce . . . ”) within a particular geographical location (e.g., “in {insert state}, {insert country}”).

To validate with the historical user engagement data 340, the seasonality module 250 obtains the historical user engagement data 340 from actions taken by requesting users on their respective client devices (e.g., which may be collected by the data collection module 210). The seasonality module 250 may generate the confidence score for each time period, e.g., confidence for TP1 352, confidence for TP2 354, etc. The seasonality module 250 may leveraging a scoring function that assigns differing contributions to different types of actions. Different types of actions by requesting users may include: searching for an item, adding an item to an order, favoriting an item, providing feedback for an item obtained, etc.

The seasonality module 250 compares the confidence score to a threshold to validate the seasonality predictions. In some embodiments, the seasonality module 250 further aggregate the confidence scores between the two different validation approaches, e.g., via an average, or a weighted average. If the score for an item category surpasses the threshold, the seasonality module 250 affirms the seasonality prediction for that item category. If the score for the item category does not surpass the threshold, the seasonality module 250 removes the seasonality prediction for that item category.

The seasonality module 250 maps items in the item catalog 360 to the inferred seasonal categories (e.g., validated with the model validation 330 and/or the engagement validation 350). The item catalog 360 may include items from the various fulfillment locations hosted by the online system 140. The seasonality module 250 may include a mapping model that maps the items to the item categories. In some embodiments, the mapping model may implement an entity-linking algorithm, a language model, or some other machine-learning model. In the example shown, the seasonality module 250 maps item 1 362 and item 2 364 in the item catalog 360 to item category 1 322 that was inferred (and, optionally, validated) to be in-season. For each mapped item, the seasonality module 250 appends (i.e., tags) an in-season badge 370. When the online system 140 generates the ordering interface 380, the ordering interface 380 will display the in-season badge 370 on each tagged item. In the example shown, the ordering interface 380 displays the in-season badge 370 tagged onto item 1 362.

### Example Methods

FIGS. 4A & 4B are example method flowcharts describing the method of inferring seasonality of items in an item catalog. Steps in each method flowchart may be performed by an online system (e.g., online system 140). Additionally, each of these steps may be performed automatically by the online system without human intervention. Alternative embodiments may include more, fewer, or different steps from those illustrated in FIG. 4, and the steps may be performed in a different order from that illustrated in FIG. 4.

FIG. 4A is a method flowchart for the method 400 of inferring seasonality of items in a catalog hosted by an online system, in accordance with one or more embodiments.

The online system 140 generates 410 a prompt for a language model to output a list of seasonal item categories based on a time period and a geographical location. The time period may be one of a plurality of time periods. The time periods may discretize a year. The geographical location may be a geographical region, e.g., state/province of a country. The prompt may include additional instructions, e.g., for formatting the response, for sorting the item categories in the output list, providing example seasonal item categories, using generic keywords, etc.

The online system 140 provides 420 the prompt to a model serving system for execution by the language model. The model serving system may execute the language model with the prompt.

The online system 140 receives 430, from the model serving system, a response generated by the language model including the list of seasonal item categories. The list of seasonal item categories may be formatted as requested by the prompt.

The online system 140 validates 440 the seasonality prediction by the language model. Validation may include generating confidence scores for time periods for an inferred in-season item category (and may further limit to the geographical location).

Referring to FIG. 4B, FIG. 4B is a method flowchart for the method 440 of validating seasonality of an item category, in accordance with one or more embodiments. The online system 140 may perform the method 440 for each item category that was inferred to be in-season. In one or more embodiments, the method 440 leverages two different validation approaches that may be used separately or in conjunction.

In a first validation approach, the online system 140 generates 441 a subsequent prompt to validate the seasonality of the item category, the subsequent prompt prompting the language model to output a seasonality confidence score for each time period. The subsequent prompt may further limit the geographical location.

The online system 140 provides 442 the subsequent prompt to the model serving system for execution by the language model.

The online system 140 receives 443, from the model serving system, a response generated by the language model including the confidence scores. The confidence scores may include a confidence score per time period.

In a second validation approach, the online system 140 receives 444 historical user engagement with items mapped to the item category. The historical user engagement may include various actions taken by requesting users with items mapped to the seasonal item category. The historical user engagement data may be limited to the geographical location, or may be across a plurality of geographical locations (e.g., nationally).

The online system 140 generates 445 a confidence score for each time period based on the historical user engagement. The online system 140 may leverage a scoring function to generate the confidence score. The scoring function may assign differing contributions for each type of action. For example, increases in user engagement during a time period may indicate that the item category is in season during that time period. Conversely, decreases in user engagement during a time period may indicate that the item category is out of season during that time period.

The online system 140 validates 446 the seasonality prediction of the item category based on the confidence scores by the language model and/or the confidence scores based on the historical user engagement. The online system may aggregate the scores between the two different approaches, e.g., via an average, a weighted average, etc. If the confidence score (via either approach, or in aggregate) is above a threshold, the online system 140 affirms the seasonality prediction for that item category. Conversely, if the confidence score does not surpass the threshold, the online system 140 invalidates the seasonality prediction for that item category. In one or more embodiments, the online system 140 correlates user engagement to predicted time periods output by the machine-learned language model.

Referring back to FIG. 4A, the online system 140 maps 450 items to seasonal item categories, tagging items mapped to a seasonal item category with an in-season badge. The online system 140 may use a mapping model to map items in the catalog to the seasonal item categories. In one or more embodiments, the online system 140 stores items in a hierarchical format in the item catalog. The online system 140 may store each item in the item catalog under one item category in a master list of item categories. Based on the validated list, the online system 140 maps item categories from the master list to one or more of the item categories in the validated list. The online system 140 tags, with the in-season badge, items stored under a mapped item category.

The online system 140 generates 460 an ordering interface to display item(s) with the in-season badge. The online system 140 may recurrently infer seasonality for item categories to ensure that the in-season badges are staying up-to-date. The ordering interface displays the in-season badges of the mapped items.

### Example Ordering Interface

FIG. 5 is an example ordering interface 500 with in-season badge 530 tagged onto an item 510, in accordance with one or more embodiments. The ordering interface 500 displays the item 510, item information 520, the in-season badge 530, and an add option 540.

The ordering interface 500 may display the item 510 in a list of items, e.g., in response to a search inquiry. The displayed item 510 may include a photograph or other image data of the item 510. The item information 520 may provide description or other relevant information relating to the item 510. The in-season badge 530 indicates that the item 510 is in-season. The in-season badge 530 may further indicate a timing of the seasonality, e.g., beginning of the seasonality period, ending of the seasonality period, etc. The add option 540 provides an input option for the requesting user to add the item 510 onto an order.

Alternative embodiments may include more, fewer, or different display components than those illustrated in FIG. 3. Other embodiments of the messaging user interface 300 may variably position each of the display components.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method executed by an online system, the method comprising:
generating a prompt for a machine-learned language model to output a list of item categories, wherein the item categories in the list are predicted to be in-season for a first time period and a geographical location of a requesting user client device;
providing the prompt to a model serving system for execution by the machine-learned language model;
receiving, from the model serving system, a response generated by the machine-learned language model including the list of item categories, wherein the item categories in the list are predicted to be in-season for the first time period and the geographical location;
validating that each item category in the list of item categories is in season for the first time period by:
retrieving historical user engagement data by requesting users of the online system with items in an item catalog corresponding to the item category,
correlating an increase in engagement level during the first time period relative to other time periods, and
validating the item category as in season for the first time period based on the correlation;
updating the item catalog by tagging, with an in-season badge, one or more items corresponding to the validated list of item categories; and
generating an ordering interface that includes the one or more items tagged with the in-season badge for display on the requesting user client device, wherein the generating causes the requesting user client device to display the ordering interface.

2. The method of claim 1, wherein the first time period is a portion of a year.

3. The method of claim 1, further comprising identifying the geographical location based on where the requesting user is located.

4. The method of claim 1, wherein generating the prompt further comprises:
generating the prompt to include instructions to order the list of seasonal item categories based on confidence in seasonality prediction.

5. The method of claim 4, wherein generating the prompt further comprises:
generating the prompt to include instructions to provide one or more example item categories known to be in-season.

6. The method of claim 1, wherein correlating the increase in engagement level during the first time period comprises applying a scoring function that disparately weights different types of actions taken by requesting users in relation to the items in the item catalog corresponding to the item category.

7. The method of claim 1, wherein validating that each item category in the list of item categories is in season for the first time period further comprises, for each seasonal item category:
generating a subsequent prompt for the machine-learned language model to output a list of time periods when the item category is in season;
providing the subsequent prompt to the model serving system for execution by the machine-learned language model; and
receiving, from the model serving system, a response generated by the machine-learned language model including the list of time periods that the item category is in season,
wherein correlating the increase in engagement level during the first time period comprises correlating the historical user engagement to the list of time periods output by the machine-learned language model.

8. The method of claim 7, wherein generating the subsequent prompt further comprises:
generating the subsequent prompt to output the list of time periods when the item category is in season further based on the geographical location.

9. The method of claim 1, further comprising:
storing each item in the item catalog under one item category in a master list of item categories; and
mapping each item category in the validated list of item categories predicted to be in season to one or more item categories in the master list of item categories,
wherein updating the item catalog comprises tagging the one or more items stored under the mapped item categories in the master list of item categories with the in-season badge.

10. The method of claim 1, wherein generating the ordering interface comprises inserting, into the ordering interface, an in-season badge that indicates a timing of the seasonality for the item.

11. A non-transitory computer-readable storage medium storing instructions that, when executed by a computer processor of an online system, cause the computer processor to perform operations comprising:
generating a prompt for a machine-learned language model to output a list of item categories, wherein the item categories in the list are predicted to be in-season for a first time period and a geographical location of a requesting user client device;
providing the prompt to a model serving system for execution by the machine-learned language model;
receiving, from the model serving system, a response generated by the machine-learned language model including the list of item categories, wherein the item categories in the list are predicted to be in-season for the first time period and the geographical location;
validating that each item category in the list of item categories is in season for the first time period by:
retrieving historical user engagement data by requesting users of the online system with items in an item catalog corresponding to the item category,
correlating an increase in engagement level during the first time period relative to other time periods, and
validating the item category as in season for the first time period based on the correlation;
updating the item catalog by tagging, with an in-season badge, one or more items corresponding to the validated list of item categories; and
generating an ordering interface that includes the one or more items tagged with the in-season badge for display on the requesting user client device, wherein the generating causes the requesting user client device to display the ordering interface.

12. The non-transitory computer-readable storage medium of claim 11, wherein the first time period is a portion of a year.

13. The non-transitory computer-readable storage medium of claim 11, the operations further comprising identifying the geographical location based on where the requesting user is located.

14. The non-transitory computer-readable storage medium of claim 11, wherein generating the prompt further comprises:
generating the prompt to include instructions to order the list of seasonal item categories based on confidence in seasonality prediction.

15. The non-transitory computer-readable storage medium of claim 14, wherein generating the prompt further comprises:
generating the prompt to include instructions to provide one or more example item categories known to be in-season.

16. The non-transitory computer-readable storage medium of claim 11, wherein correlating the increase in engagement level during the first time period comprises applying a scoring function that disparately weights different types of actions taken by requesting users in relation to the items in the item catalog corresponding to the item category.

17. The non-transitory computer-readable storage medium of claim 11, wherein validating that each item category in the list of item categories is in season for the first time period further comprises, for each seasonal item category:
generating a subsequent prompt for the machine-learned language model to output a list of time periods when the item category is in season;
providing the subsequent prompt to the model serving system for execution by the machine-learned language model; and
receiving, from the model serving system, a response generated by the machine-learned language model including the list of time periods that the item category is in season,
wherein correlating the increase in engagement level during the first time period comprises correlating the historical user engagement to the list of time periods output by the machine-learned language model.

18. The non-transitory computer-readable storage medium of claim 17, wherein generating the subsequent prompt further comprises:
generating the subsequent prompt to output the list of time periods when the item category is in season further based on the geographical location.

19. The non-transitory computer-readable storage medium of claim 11, the operations further comprising:
storing each item in the item catalog under one item category in a master list of item categories; and
mapping each item category in the validated list of item categories predicted to be in season to one or more item categories in the master list of item categories,
wherein updating the item catalog comprises tagging the one or more items stored under the mapped item categories in the master list of item categories with the in-season badge.

20. An online system comprising:
a computer processor; and
a non-transitory computer-readable storage medium storing instructions that, when executed by the computer processor, cause the computer processor to perform operations comprising:
generating a prompt for a machine-learned language model to output a list of item categories, wherein the item categories in the list are predicted to be in-season for a first time period and a geographical location of a requesting user client device;
providing the prompt to a model serving system for execution by the machine-learned language model;
receiving, from the model serving system, a response generated by the machine-learned language model including the list of item categories, wherein the item categories in the list are predicted to be in-season for the first time period and the geographical location;
validating that each item category in the list of item categories is in season for the first time period by:
retrieving historical user engagement data by requesting users of the online system with items in an item catalog corresponding to the item category,
correlating an increase in engagement level during the first time period relative to other time periods, and
validating the item category as in season for the first time period based on the correlation;
updating the item catalog by tagging, with an in-season badge, one or more items corresponding to the validated list of item categories; and
generating an ordering interface that includes the one or more items tagged with the in-season badge for display on the requesting user client device, wherein the generating causes the requesting user client device to display the ordering interface.
